(19) United States
(12) Patent Application Publication
(10) Pub. No.: US 2006/0005469 A1
(43) Pub. Date: Jan. 12, 2006

(54) Below belt channel

(76) Inventors: Rod Bara, Rochester Hills, MI (US); John Zimmer, Canton, MI (US); Eric Drozd, Farmington Hills, MI (US); Sean Scott, Walled Lake, MI (US)

Correspondence Address: Timothy E. Nauman;Fay, Sharpe, Fagan, Minnich & McKee, LLP, 7th Floor, 1100 Superior Avenue, Cleveland, OH, 44114-2518, US

(21) Appl. No.: 11/105,848

(22) Filed: Apr. 14, 2005

Related U.S. Application Data
(60) Provisional application No. 60/561,972, filed on Apr. 14, 2004.

(51) Int. Cl. E05D 15/16

(52) U.S. Cl. 49/440

(57) ABSTRACT

A below belt channel includes a rigid body formed into a generally C-shaped channel having a base and first and second outwardly extending legs. Seal lips formed from a thermoplastic, such as a thermoplastic vulcanizate (TPV), are co-extruded on outer ends of the channel legs and extend inwardly toward an interior of the channel. A low friction material is preferably provided along an interior surface of the channel base, and the seal lips may also include an extra low-friction material on the outwardly facing surfaces that contact the window glass. In one embodiment, the rigid body is either aluminum or steel and may be coated to enhance the bond with the co-extruded TPV lips, and/or provide corrosion protection. In another embodiment, the rigid body is covered in polypropylene, and a mounting bracket for supporting the channel is formed of a molded material that is compatible with the polypropylene. The molded material is then welded or fused to the body to provide a secure interconnection.

This application claims priority from U.S. provisional application Ser. No. 60/561,972, filed Apr. 14, 2004, the disclosure of which is incorporated herein by reference.

### BACKGROUND OF THE INVENTION

This application generally relates to a below belt channel that is mounted to the frame of a vehicle door below a belt line of a window opening. More specifically, this application relates to what is generally referred to as a glass run that receives or guides an edge of a vehicle window.

It is known to provide a generally C-shaped metal channel into which a similarly contoured C-shaped extrusion of EPDM is inserted. An open region of the C-shaped configuration receives an edge of the window and guides the window as the window is raised and lowered relative to the vehicle door. Brackets are spaced along longitudinal portions of the C-shaped metal support channel and the bracket(s) is secured to the door frame via fasteners or the like. These arrangements are typically stretch bent into shape.

More recently, a glass run structure has been described in published European Application EP 0699548 A2 of Kinugawa Rubber Industrial Co., Ltd. in which EPDM material is provided at open edges of a metal C-shaped channel and also an edge seal provided along an interior portion of the bottom surface of the channel. The channel is mechanically secured to a bracket via a punch and die arrangement that is intended to have little or no impact on the structural integrity of the EPDM. This type of mechanical interconnection is generally well known and was commonly used as an alternative to welding the bracket to the metal channel which could adversely impact the EPDM received in the channel.

### SUMMARY OF THE INVENTION

A new below belt bracket is provided that eliminates the use of EPDM.

Moreover, no secondary forming operations are required to manufacture/assemble the below belt bracket so that manufacturing costs are reduced.

In one arrangement, a cold rolled steel or aluminum body are formed into a generally C-shaped channel. The channel may include a galvanized coating to enhance a bond with a thermoplastic or TPV (thermoplastic vulcanizate) material. The TPV material is formed as a pair of cooperating lips that are co-extruded on the outer, terminal edges of the channel and extend inwardly toward an interior of the channel. The flexible lips preferably abut along a generally symmetrical centerline of the channel. The lips deflect inwardly into the channel and generally along the parallel length of the sidewalls of the channel when the window is received in the channel where the lips engage opposite surfaces of the window.

A low friction material is preferably provided on the base wall of the channel so that any contact of the glass run is a reduced friction surface engaging the edge of the window. The seal lips may also include a low friction material along surfaces thereof that engage the window glass

In a second preferred embodiment, the metal channel is coated with a polypropylene. The polypropylene may be talc filled. A TPV is co-extruded on the outer terminal edges of the C-shaped channel.

A molded bracket material is preferably compatible with the polypropylene on the extruded channel of the second preferred embodiment so that fusion bonding or sonic welds, preferably at spaced regions along the generally parallel sidewalls or legs and base portion of the C-shaped channel, adequately secure the channel to the bracket.

A primary benefit of the invention resides in the one piece design that is efficiently and economically manufactured.

Another benefit of the invention relates to the swept in-line manufacture of the below belt channel, i.e., the channel is bent as it proceeds from the extruder and before the assembly is cut to length.

Still another embodiment is associated with use of a thermoplastic such as TPV that replaces conventionally used EPDM for the manufacture of the seal lips.

Still other features and benefits and advantages of the invention will become apparent to one skilled in the art after reading and understanding the following detailed description.

### BRIEF DESCRIPTION OF THE DRAWINGS

FIGS. 1-4 illustrate a first embodiment of a below belt channel formed in accordance with the present invention.

FIGS. 5-8 illustrate a second embodiment of a below belt channel according to the present invention.

### DETAILED DESCRIPTION OF THE INVENTION

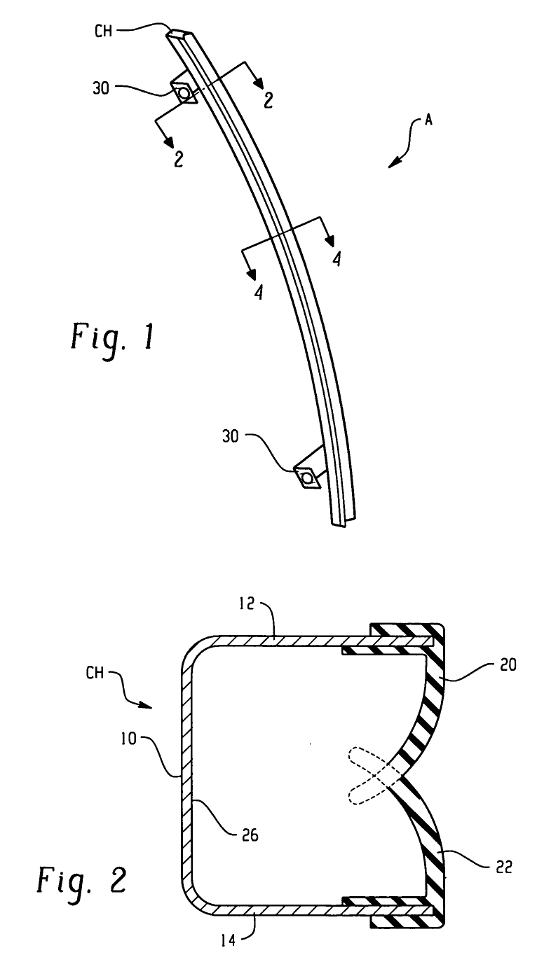

FIGS. 1-4 illustrate a below belt channel assembly A including a generally C-shaped body or channel CH such as aluminum or steel. The metal is formed by a series of rollers (not shown) into the desired C-shape comprising a base portion 10 having outwardly extending sidewalls or legs 12, 14. The channel then proceeds through an extruder where plastic, preferably TPV, seal lips 20, 22 are extruded onto outer, terminal edges of the channel legs 12, 14, respectively. Preferably no adhesion coating is required to bond the TPV to the metal as perhaps best illustrated in the cross-sectional views of FIGS. 2-4, taken generally along the lines 2-2 and 4-4 of FIG. 1. However, the metal channel may be coated to enhance a bond with the plastic or TPV lips and/or provide corrosion resistance. For example, the metal could include a pre-treatment layer or coating typically for purposes of anti-corrosion, a primer, and an adhesive. Of course, the preferred arrangement would be to eliminate the use of any coating on the metal, however, one skilled in the art will appreciate that various combinations of one or more of these layers may be used. For instance, no pretreatment may be desired in which case the adhesive bonds directly to the metal and directly to the plastic. Alternatively, if no adhesive is used, the metal may be abraded, mechanically or chemically, so that the plastic bonds directly to the metal. Yet, in other instances, use of the pretreatment, primer, and adhesive may be warranted. A preferred material composition is one or more of the following: epoxy, acrylic, urethane, olephonic, phenolic, and cylene materials.

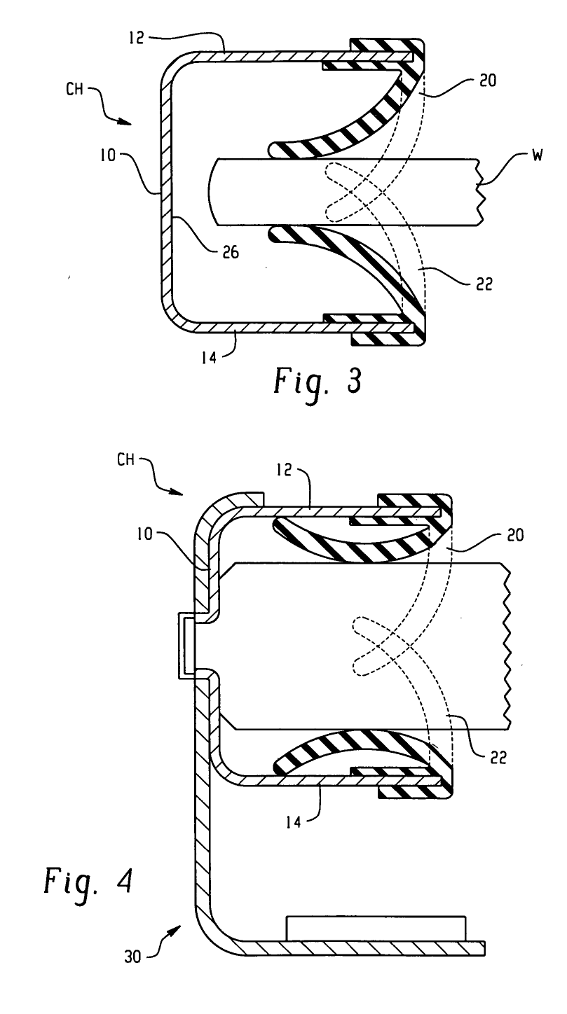

The base portion 10 further incorporates a low friction material 26 on an interior surface thereof to provide a low friction glass contact area. Likewise, the low friction material may be coated on the outwardly facing surfaces of the TPV so that upon receipt of the edge of the window glass W (FIG. 3), little friction results therebetween. It is required to cool the extruded TPV, the channel with extruded lips is swept in-line to conform with the window glass, and then is subsequently cut to length. Having the channel swept in-line is a departure from prior lower belt brackets where the bracket was first cut, and then bent to the desired contour. This results in a significant savings in not only tooling expenses, but also provides a process where the process is more controllable and adjustable as the channel proceeds through the manufacturing line. It will also be appreciated, however, that not all brackets are swept in-line.

Brackets 30 (FIGS. 1 and 4) are secured at longitudinally spaced locations to secure the channel to the vehicle frame below the belt of the door opening. For example, first and second brackets 30 are shown in FIG. 1 to secure the channel to the door frame (not shown). As evident in FIG. 4, the brackets are preferably a metal structure such as cold rolled steel that is mechanically secured to the base portion of the channel. It is contemplated that as the channel exits the manufacturing/extruding line, the cut part will be positioned in a press with the desired number of brackets (for example, two brackets for each channel), and a die lances/locks the metal brackets to the channel, and cuts the ends. This should be contrasted to the old process of stretch bending the component, attaching the bracket, cutting and trimming each bracket, then trimming the rubber and securing the rubber into the bracket. Thus, it will be appreciated that a substantial reduction in manufacturing and assembly steps is achieved with this new arrangement.

As shown in FIGS. 2-4, the details of the seal lip and its relationship with the channel are evident. Particularly, the seal lip is extruded over inner and outer portions of the channel in order to effectively secure the seal lips to the channel. Preferably, the extruded material extends over a portion of the outer surface of the channel because on occasion when the channel is mounted to the vehicle, the window could inadvertently slip behind the bracket. Without this extruded plastic portion on the outer surface, the window could be scratched by the metal.

In addition, the extrusion extends over a greater portion of the inner surface of the channel legs than it does on the outer surface of the channel legs. This increased section is for bonding strength of the TPV to the channel. It would be undesirable for the TPV to delaminate from the channel as the window traverses so it is important to assure a secure bond between the TPV and metal channel.

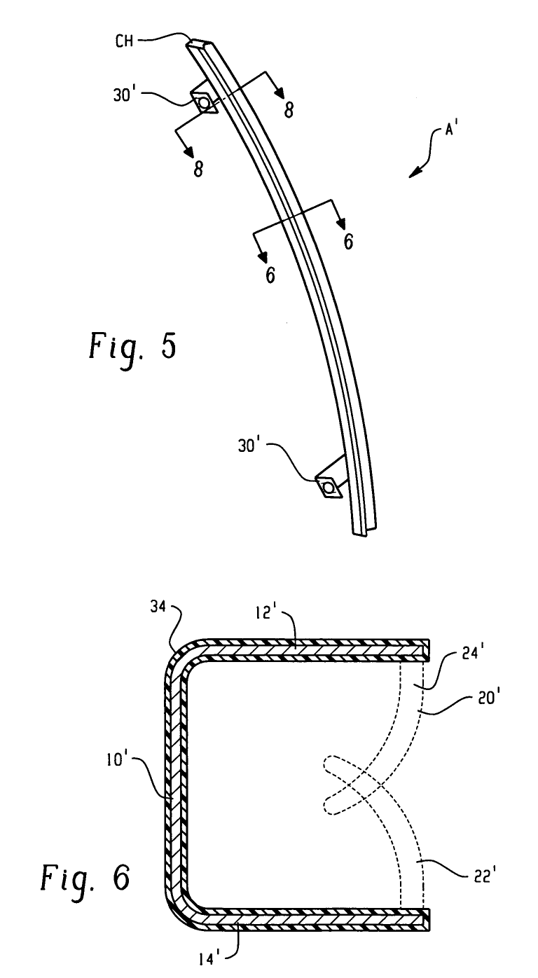

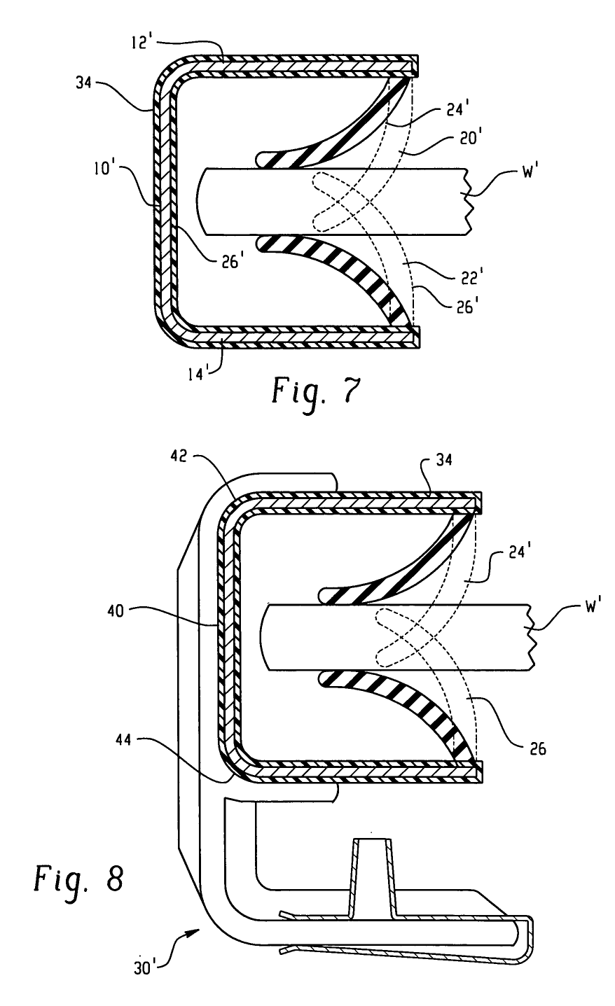

The second embodiment of FIGS. 5-8 also includes a metal, C-shaped structure (like components are identified by like numerals with a primed suffix and new components identified by new reference numerals) having a base 10′ and outwardly extending legs 12′, 14′. A talc filled polypropylene 34 encases or coats the metal channel along the base and extending legs. Seal lips 20′, 22′ are co-extruded on the outer terminal ends of the C-shaped channel. Preferably, a thermoplastic such as a TPV (for example, available under the trademark Sarlink provided by DSM) is used, and it is desirable that the encasing polypropylene be compatible with any coating that is provided on the channel so that the plastic fuses to the channel. The lips may further include an extra-low friction material on the outwardly facing surfaces 24′, 26′ of the seal lips. This provides an extra-low friction glass contact area for those regions of the seal lip that frictionally engage the window (FIG. 7).

By encompassing the metal channel in the polypropylene, a modified bracket 30′ is provided. For example as shown in FIG. 8, the bracket is a molded material that is compatible with the polypropylene, preferably a plastic. The molded material is then sonically welded at locations 40, 42, 44 along the base and outwardly extending legs of the channel. This provides a secure interconnection with the channel without adversely impacting the seal lips or remaining structural integrity of the channel.

The invention has been described with reference to the preferred embodiments. Of course, modifications and alterations will become apparent to those of ordinary skill in the art, and the invention should not be limited to the described embodiments.

Having thus described the invention, it is now claimed:

1. A below belt channel for supporting an edge of an associated vehicle window, the below belt channel comprising:
a rigid metal body having first and second legs extending from a base and formed in a generally C-shaped channel; and
first and second thermoplastic lips extruded over outer ends of the first and second legs, respectively.

2. The below belt channel of claim 1 further comprising a low friction material on the base of the channel.

3. The below belt channel of claim 1 further comprising a low friction material on at least one surface of the first and second lips.

4. The below belt channel of claim 1 wherein the body includes at least one of a primer, an adhesive, and an anti-corrosion layer.

5. The below belt channel of claim 1 wherein the body includes a galvanized coating.

6. The below belt channel of claim 1 wherein the metal body is coated with a plastic.

7. The below belt channel of claim 6 wherein the plastic is a polypropylene.

8. The below belt channel of claim 6 further comprising brackets secured to the body at spaced locations for mounting to an associated vehicle.

9. The below belt channel of claim 6 wherein the bracket is formed from a material compatible with the plastic coated on the body whereby the bracket and body plastic are fusion welded together.

10. The below belt channel of claim 1 wherein the first and second lips each include a mounting region that is received over inner and outer surfaces of the respective leg.

11. The below belt channel of claim 1 wherein the first and second lips extend inwardly toward the other leg and sweep toward the base.

12. The below belt channel of claim 1 wherein the first and second lips are secured to the first and second legs, respectively, without any adhesive.

13. The below belt channel of claim 1 wherein the body is swept along a curve to meet a contour of an associated window.

14. A below belt channel comprising:
a metal body including first and second legs extending outwardly from a base in generally parallel relation, the body having a coating over the metal;
co-extruded thermoplastic seal lips on outer end portions of the legs only, each seal lip including a first portion bonded to a respective leg and a second portion extending toward the other leg.

15. The below belt channel of claim 14 wherein each seal lip includes an extra low friction material received on a surface thereof that is adapted for engagement with an associated window.

16. The below belt channel of claim 14 further comprising a low friction material on the base adapted for potential engagement with an associated window.

17. The below belt channel of claim 14 wherein the coating is a galvanized coating for corrosion protection.

18. The below belt channel of claim 14 further comprising a bracket, and wherein the coating is a plastic that is fusion bonded to the bracket.

19. A method of forming a below belt channel comprising the steps of:
providing a metal channel having first and second legs extending from a base;
co-extruding a thermoplastic seal lip on to each leg; and
sweeping the channel with the co-extruded lips to conform to travel of an associated window.

20. The method of claim 19 comprising the further steps of providing a bracket for supporting the channel in an associated vehicle, coating the metal channel in plastic, and fusion bonding the bracket to the plastic of the channel.
